(19) United States
(12) Patent Application Publication
(10) Pub. No.: US 2008/0228628 A1
(43) Pub. Date: Sep. 18, 2008

(54) REGISTRATION METHOD AND SYSTEM FOR AN ENVIRONMENTAL COMMODITIES EXCHANGE

(76) Inventors: Philip Gotthelf, Closter, NJ (US); Nathan Guedalia, Fort Lee, NJ (US)

Correspondence Address: ADELI & TOLLEN, LLP, 1875 CENTURY PARK EAST, SUITE 1360, LOS ANGELES, CA, 90067, US

(21) Appl. No.: 12/047,289

(22) Filed: Mar. 12, 2008

Related U.S. Application Data
(60) Provisional application No. 60/894,380, filed on Mar. 12, 2007.

(51) Int. Cl. G06Q 40/00

(52) U.S. Cl. 705/37

(57) ABSTRACT

Some embodiments provide a method of registering various types of environmental conservation items such as products, projects, or technologies with sets of environmental conservation properties through an electronic interface. In some embodiments, the electronic interface allows registrants the ability to register an environmental conservation item using only a minimal set of identification data, where the identification data includes at least one parameter for identifying the item. The electronic interface facilitates the registration of the item by associating the set of environmental conservation properties to the item.

Some embodiments provide a trading platform to facilitate the buying, selling, and trading of credits. In some such embodiments, the trading platform directly interfaces with the trading platforms of other exchanges in order to unify the buyers, sellers, and credits from all such trading platforms into a single unified interface.

### CLAIM OF BENEFIT TO PRIOR APPLICATION

This application claims benefit to U.S. Provisional Patent Application 60/894,380, filed Mar. 12, 2007. This United States Provisional Patent Applications is incorporated herein by reference.

### FIELD OF THE INVENTION

The present invention relates to an environmental commodities exchange system and method. Specifically, to a method and system for registering environmental conservation items and providing a trading platform for buying, selling, and exchanging of environmental credits.

### BACKGROUND OF THE INVENTION

Environmental regulations and stricter emissions controls are being advocated throughout various jurisdictions and countries in response to ever increasing concern over global warming. Global warming relates to the phenomenon in which an increase of carbon dioxide and other greenhouse gases within the Earth's atmosphere trap additional heat from the sun within the atmosphere causing climate change.

Several proposals have been set forth to curtail and reduce carbon and greenhouse emissions. One such proposal is set forth within the Kyoto Protocol, a 1997 international treaty that began taking effect in 2005. The Kyoto Protocol creates a commodities market in which allowances for emissions referred to as Carbon Credits, are purchased, sold, and traded.

Under the Kyoto Protocol, a central authority such as a governmental agency sets forth a limit for the amount of emissions that can be emitted by businesses and industries within the agency's jurisdiction. The stated goal to reduce emissions from the atmosphere involves creating incentives for and promoting emissions reducing business practices by providing a specified allotment of emissions allowances to these particular businesses and industries. Those businesses, industries, and even countries with efficient and environmental friendly operating practices can sell their unused allotment of Carbon Credits to other businesses, industries, and countries that have exceeded their allotment of emissions allowances. In this manner, heavy polluters can offset their excessive polluting activities by purchasing additional Carbon Credits or can improve their business practices to leave a smaller environmental footprint via more environmental friendly processes or manufacturing.

Some emissions reducing exchange models allow for the generation of new credits based on a set of standards that measure the emissions reductions provided by various products, projects, or technologies. Once the emissions reductions provided by such products, projects, or technologies reach a specified amount, a Carbon Credit is issued. The Acid Rain Program of the 1990 Clean Air Act in the United States is an example of a functioning emissions trading system for reducing sulfur dioxide (SOX) from the atmosphere.

There currently exist exchange systems for trading Carbon Credits (e.g., the Chicago Climate Exchange (CCX)). However, the functionality of these exchanges remains outside the reach of common consumers and small entities. In order to issue a tradable Carbon Credit within the CCX and other established exchanges, one must typically accumulate the equivalent of one metric ton of carbon emissions reduction or its equivalent. As a result, individual consumer purchases and small scale emissions reducing projects cannot become participants in the exchange. As such, these potential participants are dissuaded and in some instances restricted from participating in the emissions reducing market.

Therefore, there is a need for a comprehensive exchange system whereby participants of any size can participate. There is a need for the exchange system to reward participants of all qualities and quantities while still maintaining a widely-accepted definition for the trading commodity. Furthermore, there is a need for a scalable exchange system to accommodate various forms of environmental tradable commodities and credits. For example, in addition to creating credits for and providing a platform for emissions reductions, the exchange system should include: (1) tradable commodities that represent amounts of energy conservation associated with the use or application of newly developed products, projects, and technologies, (2) tradable commodities that represent amounts of properly disposed of or recycled hazardous materials and waste, (3) tradable commodities that represent quantifiable amounts of newly generated renewable energy. The exchange system should further scale to account for any new types of emissions, energy savings, hazardous waste and the associated products, projects, or technologies. The system should provide a level of convenience and automation thereby making the system accessible irrespective of the types of environmental tradable commodities, the sizes of the particular contributions by a user, and the knowledge of the users such that first time users are able conveniently participate in the system and are able to receive a benefit from their participation.

### SUMMARY OF THE INVENTION

Some embodiments provide a method of registering various types of environmental conservation items such as products, projects, or technologies with sets of environmental conservation properties through an electronic interface. In some embodiments, the electronic interface allows registrants the ability to register an environmental conservation item using only a minimal set of identification data, where the identification data includes at least one parameter for identifying the item. The electronic interface facilitates the registration of the item by associating the set of environmental conservation properties to the item.

Based on the associated set of environmental conservation properties of an item, some embodiments generate an environmental conservation value to represent the quantified environmental conservation in the form of a numerical value. The environmental conservation value is used to compensate the registrant for his/her contribution. Compensation in some embodiments includes distribution of a monetary sum or a rebate. The environmental conservation values are then, independently or in conjunction with the environmental conservation values of other items, used to issue a tradable credit. In some embodiments, the credits are placed onto a trading platform whereby buyers and sellers are provided a means by which to buy, sell, and trade such credits.

In some embodiments, the trading platform is facilitated through a direct interface into the trading platforms of other exchanges. Some embodiments utilize an electronic interface and a pseudo-account to facilitate trading operations with one or more different trading platforms on behalf of users without requiring the users to be members of the trading platforms. Moreover, some embodiments provide users access to the trading platforms without requiring the users to become knowledgeable of the procedures, interfaces, or standards of the other exchanges.

In conjunction with or instead of directly trading the credits on the trading platforms of the other exchanges, some embodiments retrieve in real-time the trading data of at least two trading platforms of at least two different exchanges using the communicably coupled interface. The retrieved data of all such trading platforms is unified and presented to the users of some embodiments through a single electronic interface. Accordingly, users may buy, sell, and trade the credits of some or all other exchanges through the single electronic interface without having to register with or become knowledgeable of the procedures, interfaces, or operations of the other exchanges. As a result, some embodiments provide buyers a larger pool of potential sellers while also providing sellers a larger pool of potential buyers through the convenience of an electronic interface.

### BRIEF DESCRIPTION OF THE DRAWINGS

FIG. 1 illustrates an exemplary registration process provided by some embodiments of the invention.

FIG. 2 illustrates how some embodiments directly facilitate the buying, selling, and trading of environmental credits by providing an independent trading platform.

FIG. 3 illustrates how some embodiments directly interface with the trading platforms of other exchanges.

FIG. 4 illustrates how some embodiments directly interface with the trading platforms of other exchanges in order to retrieve in real time the trading data of such exchanges so that such data can be presented through a single unified interface.

FIG. 5 presents an architectural diagram of some embodiments of the exchange system.

FIG. 6 illustrates an initial registration interface from which users select a registration type that classifies the user in order to provide subsequent interfaces based on the functionality associated with the user classification.

FIG. 7 presents an illustrative interface presented to a user classified as a consumer.

FIG. 8 illustrates an interface presented to a user registering one or more environmental conservation items.

FIG. 9 presents an illustrative interface for specifying environmental conservation properties for an item.

FIG. 10 presents an illustrative interface showing the computed amount of environmental conservation resulting from one or more registered items.

FIG. 11 presents a process that conceptually illustrates several operations performed by the registration engine for registering an environmental conservation item.

FIG. 12 presents an illustrative interface for a manufacturer defining new environmental conservation items into an items database in accordance with some embodiments of the invention.

FIG. 13 presents an illustrative interface for a manufacturer defining additional properties of a newly defined item and a protocol that specifies the heuristics for converting the environmental conservation properties of the item into a quantifiable amount of environmental conservation.

FIG. 14 presents a process that conceptually illustrates several operations performed for implementing the functionality of an exemplary trading platform in accordance with some embodiments of the invention.

FIG. 15 illustrates how some embodiments directly interface with the trading platforms of other exchanges through a communicably coupled interface.

FIG. 16 presents a process that conceptually illustrates several operations performed by the trading engine to leverage the trading platforms of other exchanges by unifying and presenting the trading data of such exchanges into a single interface that is accessible through an electronic interface.

FIG. 17 conceptually illustrates how some embodiments of the invention create a unified trading platform that includes the credits of various other exchanges.

FIG. 18 illustrates the facilitation of environmentally friendly practices and products and the cost offsetting for such practices and products between buyers and sellers as provided for by some embodiments.

FIG. 19 conceptually illustrates a computer system with which some embodiments of the invention are implemented.

### DETAILED DESCRIPTION

In the following detailed description of the invention, numerous details, examples and embodiments of the invention are set forth and described. However, it will be clear and apparent to one skilled in the art that the invention is not limited to the embodiments set forth and that the invention may be practiced without some of the specific details and examples discussed.

I. Overview

Some embodiments provide a method of registering various types of environmental conservation items such as products, projects, or technologies with sets of environmental conservation properties through an electronic interface. In some embodiments, the electronic interface allows registrants the ability to register an environmental conservation item using only a minimal set of identification data, where the identification data includes at least one parameter for identifying the item. The electronic interface facilitates the registration of the item by associating the set of environmental conservation properties to the item where the properties specify a quantifiable amount of environmental conservation associated with the item, such as a quantifiable amount of emissions reductions, energy conservation, reduction in hazardous waste or materials, or generated renewable energy. In this manner, the environmental conservation properties associated with the item are automatically entered and the registrant is thus removed from the complexities of having to become knowledgeable of and provide the environmental conservation properties for a given item.

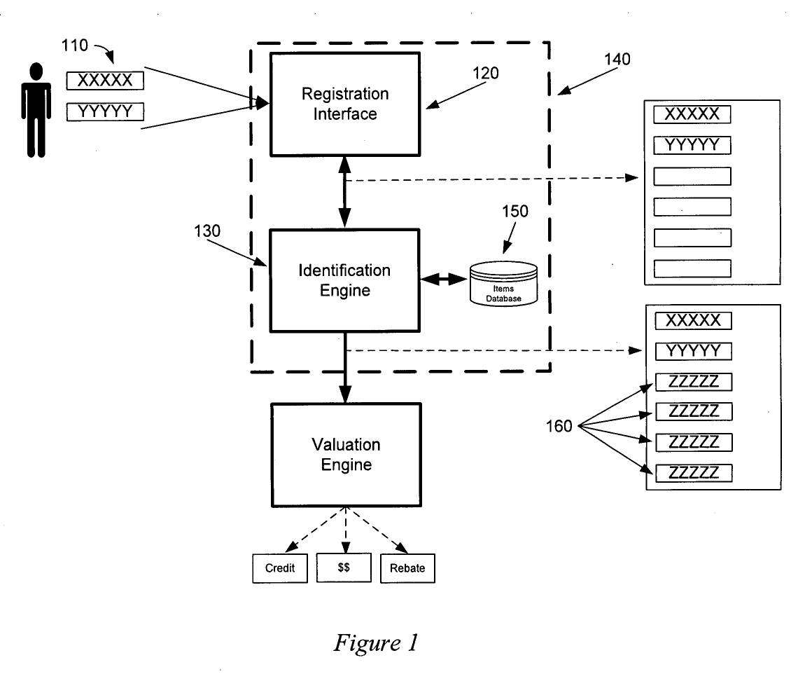

FIG. 1 illustrates an exemplary registration interface in accordance with some embodiments of the invention. In FIG. 1, the registrant need only identify an item via a minimal set of identification data 110 through the electronic registration interface 120 provided by the registration engine 140. The identification data 110 includes at least one parameter for uniquely identifying the item and one or more parameters to identify the registrant (e.g., name, address, etc.). In some embodiments, the minimal set of identification data 110 includes readily identifiable information such as a universal product code (UPC) in conjunction with an item's serial number.

Once entered into the registration interface 120, the identification data 110 is passed to an identification engine 130 of the registration engine 140 that additionally may include a database 150 for storing items and the associated set of properties 160 for the items. The identification engine 130 searches the items database 150 in order to identify the item and its associated set of environmental conservation properties 160. The information is then retrieved from the items database 150. The retrieved set of properties 160 are then automatically entered into the registration interface 120 without any further action by the registrant. At this point, all necessary information for registering an environmental conservation item is complete.

For example, if a registrant provides a UPC and serial number to identify an energy efficient light bulb's make and model, then the registration interface automatically provides the luminance, average life cycle, expected kilowatt hours used over the life cycle, material composition, and the protocol needed to compute the environmental conservation value associated with the energy efficient light bulb. In this manner, the registrant need not become familiar with nor does the registrant have to provide the detailed environmental conservation parameters of the item. Such information may not be known or readily available to the ordinary consumer. Nevertheless, such information is required to register the item and later compute the environmental conservation value associated with the item. It should be apparent to one of ordinary skill in the art that various other environmental conservation properties or different properties may be associated with the same item or different items.

Based on the retrieved set of environmental conservation properties, some embodiments generate an environmental conservation value to represent the quantified environmental conservation in the form of a numerical value. The environmental conservation values are then independently or in conjunction with the environmental conservation values of other items used to issue a tradable credit. Since the tradable credits contain an intrinsic monetary value, some embodiments compensate the registrant based on an amount of the environmental conservation value contributed to the overall formation of the credit. In some embodiments, the credits are placed within a trading platform, whereby buyers and sellers are provided a means by which to buy, sell, and trade such credits.

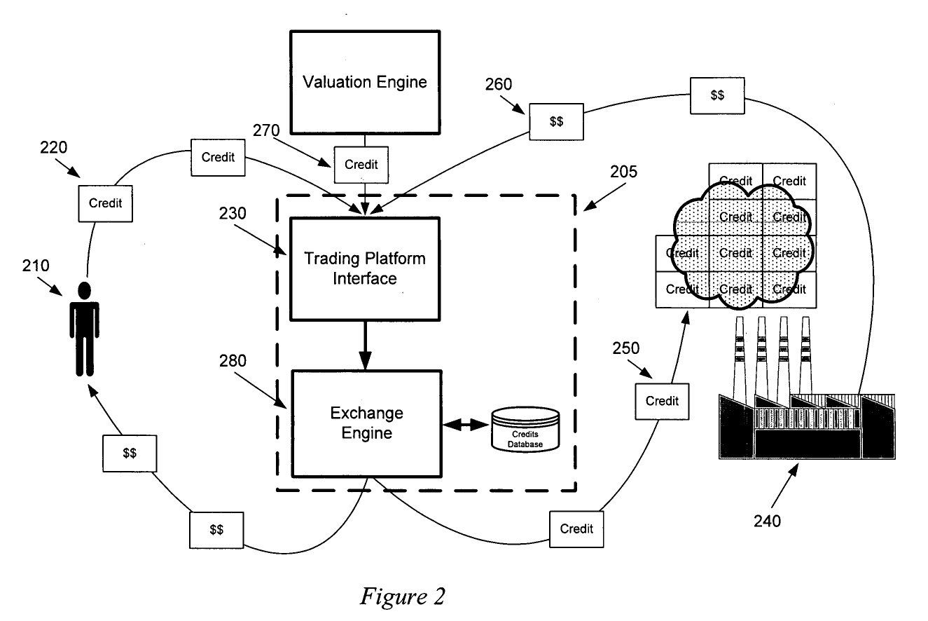

FIG. 2 illustrates how some embodiments directly facilitate the buying, selling, and trading of environmental credits by providing an independent trading platform. In some embodiments, the independent trading platform is implemented through functionality provided by the trading engine 205. The trading engine 205 includes a trading platform interface 230 through which users and other entities access the functionality provided by the exchange engine 280.

In FIG. 2, a selling entity 210 in possession of credits 220 registers its credits 220 through the trading interface 230. Similarly, a credit 270 that was generated through the registration process of FIG. 1, can be placed within the trading engine to be bought, sold, or traded. To purchase such credits, a buying entity 240 similarly accesses the trading interface 230. From the trading interface 230, the credits of entity 210 and the internally issued credits 270 are made available for purchase by entity 240. As will be described in further detail below, purchasing credits may be useful to offset the buying entity's 240 polluting activities.

The buying entity 240 purchases an amount of credits 250 in exchange for a monetary amount 260. The exchange engine 280 processes the purchase request and automatically performs the functionality necessary to complete the transaction between seller 210 and buyer 240 such that the buyer 240 receives the credit and the seller 210 receives the monetary amount 260. Moreover, though the compensable amount 260 in FIG. 2 represents some form of monetary compensation, it should be obvious to one of ordinary skill in the art that the compensable amount 260 may additionally or alternatively include other forms of payment such as rebates issued by utilities.

In some embodiments, the trading engine further facilitates the buying, selling, or trading of credits by directly interfacing with the trading platforms of other exchanges. In this manner, some embodiments are able to leverage the buyers, sellers, and credits of two or more exchanges thus creating a larger more accessible pool of buyers, sellers, and credits. Traditionally, a buyer of credits that has registered with a traditional exchange is limited to the available pool of credits and potential set of sellers within that exchange only. However, a buying entity with access to the trading engine of some embodiments is provided a larger pool of potential sellers as the buying entity is given access to the credits and sellers of all communicably coupled trading platforms.

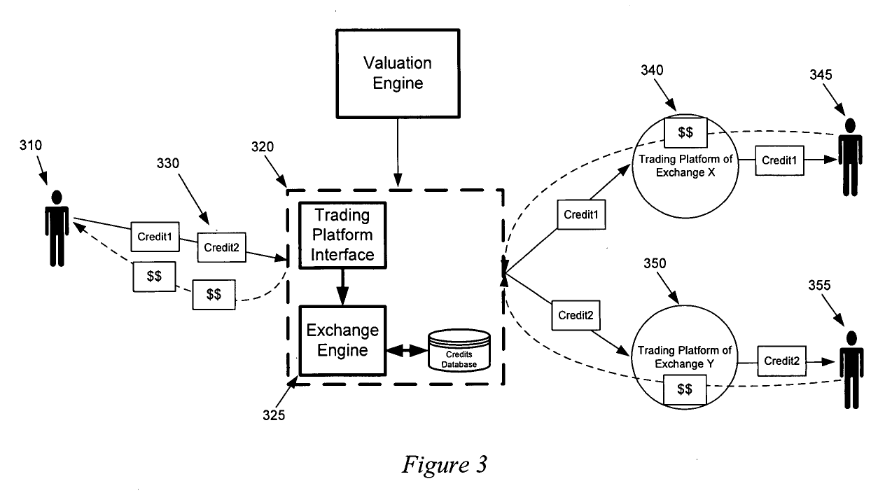

Some embodiments utilize an electronic interface to communicably couple or establish the direct interface with the trading platforms of the other exchanges. Through the direct interface, some embodiments perform the placement, buying, selling, and trading of credits on behalf of the users or owners of such credits. FIG. 3 illustrates the directly interfaced trading platform of some embodiments. Specifically, in FIG. 3, an entity 310 registers and interfaces with the trading engine 320 using the trading platform interface. From the single interface provided by the trading engine 320, the entity 310 is able to place its available credits 330 onto the trading platforms of several other exchanges in order to buy or sell credits on all such platforms whether or not the entity 310 is a registered entity of those exchanges.

The functionality of the trading engine 320 allows for the entity 310 to sell its credits across several desired exchanges by acting on behalf of the entity 310 when interfacing with the other exchanges. For instance, the exchange engine 325 uses a pseudo-account to emulate a participant of the other exchanges. Through this pseudo-account, the exchange engine 325 executes operations on behalf of the entity 310. Accordingly, the entity 310 and other entities are able to selectively place different credits on different exchanges all through the pseudo-account provided by the exchange engine 325. A first credit is placed on the trading platform of a first exchange 340 and a second credit is placed on the trading platform of a second exchange 350 without requiring the entity 310 to become familiar with, register with, or have to interface with each exchange separately.

This allows the entity 310 to have access to the buying entities 345 of the first exchange 340 and also the buying entities 355 of the second exchange 350. The entity 310 thus has access to a larger pool of buyers, increasing the likelihood of selling the credits 330 at a higher price. Though FIG. 3, was described with reference to entity 310 selling credits, it should be apparent to one of ordinary skill in the art that the trading platform 320 of FIG. 3 can similarly facilitate the buying of credits for a buying entity by directly interfacing with the other exchanges on behalf of the buying entity. To provide such functionality, some embodiments of the trading engine retrieve in real-time the trading data of at least two trading platforms of at least two different exchanges using the communicably coupled interface. In this manner, the retrieved data of all such trading platforms can be unified and presented to the users of some embodiments through a single electronic interface.

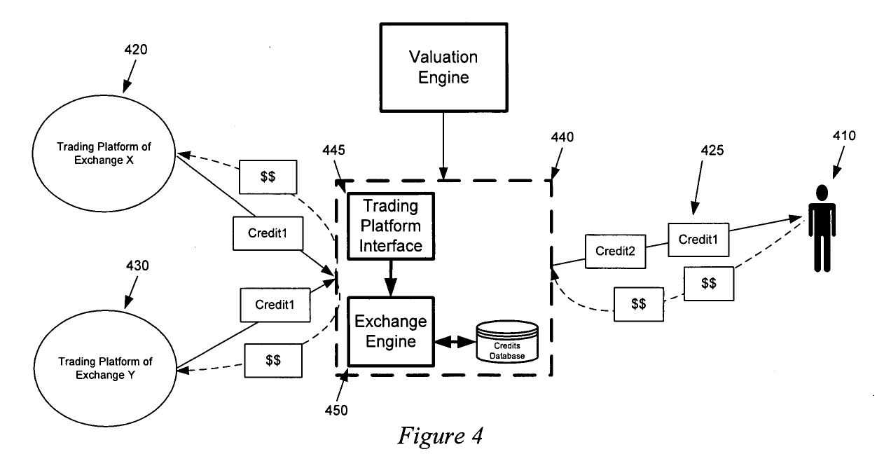

FIG. 4 illustrates how some embodiments retrieve some or all the trading data from at least two other exchanges 420 and 430 and present the information through a single unified interface 445 provided by the trading engine 440. From the single interface 445, a buying entity 410 is permitted simultaneous and real-time access to the trading platforms of several various environmental commodities exchanges 420 and 430. The entity 410 is thus provided a larger pool of available sellers from which to purchase credits. Further still, the entity 410 is provided such functionality without having to become familiar with and register with each such trading platform. Instead, the buying entity 410 need only be familiar with the single unified 445 interface provided by some embodiments of the trading engine 440. The entity 410 can thus purchase credits of the other exchanges seamlessly through the trading platform's interface 440. Buy, sell, trade, and other operations are routed through the exchange engine 450 to the other exchanges 420 and 430 where they are locally executed as described above with reference to FIG. 3.

Moreover, some of the other exchanges currently do not provide an electronic or computer implemented trading platform. By retrieving the data of such embodiments and integrating such data within the trading engine, some embodiments further provide an electronic interface for the trading platforms of the other exchanges that lack such functionality.

Several more detailed embodiments of the invention are described in the sections below. Before describing these embodiments further, a definition as to the terms and concepts used by some embodiments is given in Section II below. This discussion is followed by the discussion in Section III of an overview of the environmental commodities exchange system architecture used by some embodiments to implement the registration, qualification, quantification, valuation, bundling, and trading functionality. Section IV describes various implementations for the registration engine. Section V describes various implementations for the trading engine. Lastly, Section VI describes a computer system for implementing some of the embodiments of the invention.

II. Definitions

In some embodiments, the credits are tradable environmental commodities that represent various kinds or amounts of emissions. In some embodiments, the emissions include various greenhouse gases and environmental pollutants, such as carbon dioxide, ozone, methane, nitrous oxide, sulfur dioxide, hydrofluorocarbons, perfluorocarbons, sulfur hexafluoride, various refrigerants, and other effluents into the environment. Such emissions include atmospheric and non-atmospheric emissions.

Additionally, the credits of some embodiments represent more generalized forms of energy savings, energy conservation, hazardous waste reduction, or renewable energy. For instance, credits representing reductions in the usage of energy include reductions in the usage of kilowatt hours, gas British thermal units (“BTU's”), propane, and coal as some examples. It will be apparent to one of ordinary skill in the art that various other reductions in the usage of energy are similarly covered within the scope of the invention.

In some embodiments, credits that represent some quantifiable reduction in the amount of hazardous waste or materials are provided a compensable value in the form of a municipality issued rebate or utility approved rebate when an item containing hazardous waste or materials is properly disposed of. This value is determined through the quantity and quality of the hazardous material or waste within the item. For instance, a small amount of highly radioactive material that is properly disposed of may result in a similar value as a large amount of mercury that is properly disposed of, where a proportional amount of mercury is relatively less toxic than that of the highly radioactive material.

In this manner, an incentive is created to remove such hazardous waste or materials from traditional landfills, where such toxins can contaminate the soil or seep into the water supply. For instance, the proper disposal of light bulbs or computer components containing mercury or lead, batteries containing toxic metals such as alkaline, lithium, and nickel-cadmium, and light ballasts containing polychlorinated biphenyls (PCBs) removes these toxic materials from landfills and instead moves the toxic materials to a facility where they can be properly and safely disposed of or even recycled. Moreover, the administration and oversight regarding the rebates is removed from the municipality or utility and is instead given to some embodiments where it is readily facilitated through a computer implemented interface.

It will be apparent to one of ordinary skill in the art that various other solids, liquids, contained gases, or sludges that are a result of by-products from manufacturing processes or discarded products that potentially can contaminate the soil, water supply, or cause other environmental harm are similarly covered within the scope of the invention. The Environmental Protection Agency (EPA) has issued certain lists (e.g., F-list for non-specific source wastes, K-list for source-specific wastes, P-list and U-list for discarded commercial chemical products) to cover certain recognized wastes with certain ignitable, corrosive, reactive, or toxic properties that would be applicable to some embodiments of the invention.

In some embodiments, the credits also represent standard or pre-defined amounts of generated renewable energy. Such renewable energy includes energy created from wind farms or solar farms as some examples, though renewable energy may be derived from other renewable sources such as geothermal heat, biomass, landfill waste, or by-products of farming operations.

The generated renewable energy can be sold back into the electric grid, but can also be used to determine some quantifiable amount of emissions reduction. Since, the generated renewable energy was created without producing atmospheric emissions, there is a quantifiable amount of emissions reductions attributable to the amount of generated renewable energy. Specifically, every unit of renewable energy that is created and sold back into the electric grid results in one fewer unit of energy that has to be created from traditional polluting means.

The credits of some embodiments may also take the form of rebates that are issued by municipalities or various other regulatory agencies for meeting certain criteria in environmental conservation. Such environmental conservation includes receiving rebates for the purchase and installation of a water heater with energy ratings that fall within a specified threshold or for the proper disposal of items containing hazardous materials that could otherwise harm the environment if placed within a landfill.

In some embodiments, the environmental conservation items include various products, projects, and technologies that quantifiably impact the environment to result in a measurable about of environmental conservation. In some embodiments, an environmental conservation product is a product with some less efficient or less environmentally friendly pre- existing analog. Since efficient environmental conservation products consume less energy, less energy needs to be produced. Power plants that generate the energy consumed by the products produce a certain amount of greenhouse gases with every unit of generated energy and consumed energy. Therefore, the equivalent use of a more efficient product compared to a less efficient analog product requires less energy to be produced resulting in fewer greenhouse emissions from the power plant. For instance, hybrid vehicles as opposed to traditional combustion engine vehicles consume less gasoline per mile driven. Since the combustion process for converting gasoline into energy is mainly responsible for the carbon dioxide emissions associated with automobiles, combusting less gasoline results in less carbon dioxide being released into the atmosphere. Similarly energy efficient lighting, such as compact fluorescent light bulbs as opposed to less energy efficient incandescent light bulbs, consume less electricity over their respective lifetimes to produce an equivalent amount of light. Since a unit of electricity that is consumed is typically derived from some polluting power generating process (e.g., natural gas power plants, coal fueled power plants), the fewer units of electricity consumed, the fewer the amount of pollutants produced.

Environmental conservation projects include processes such as carbon sequestering that remove or reduce atmospheric greenhouse emissions. Additionally, some projects may generate energy thereby reducing the amount of pollution associated with other power generating activities. In some embodiments, the environmental conservation associated with a project contains some overlap with products. For example, a lighting retrofit project involves replacing older inefficient light bulbs for an entire building or enterprise with newer efficient light bulbs. Such a project provides a level of environmental conservation by virtue of the products used within the product. As such, the environmental conservation associated with these projects and products may be registered only once.

Similarly, a newly developed technology without any previously existing analog that reduces energy usage, emissions, or cleanly produces energy over traditional means would have a set of associated environmental conservation properties that could be used to quantifiably compute the environmental conservation associated with the item. An example of such a technology would be a viable commercial implementation of cold fusion.

The quantifiable impact of such items is determined through the various environmental conservation properties of the items that include attributes or characteristics of the item that identify an amount of emissions reductions, energy conservation, reduction in hazardous materials/waste, or generated renewable energy associated with the use or application of the item. From the set of properties, an environmental conservation value is determined and associated with the item. In some embodiments, the environmental conservation value represents a numerical quantification of the amount of environmental conservation that results from the item over its useful life. Specifically, a typical quantifiable metric in defining the environmental conservation value for an item is to measure the amount of carbon dioxide (CO2) emissions associated with a particular item over its useful life.

The environmental conservation values are computed using one or more protocols. Protocols compute the environmental conservation values over an item's set of environmental conservation properties. Additionally, some embodiments compute the environmental conservation values based on an actual use or implementation of the device through various qualification parameters. The qualification parameters relate the actual amount of environmental conservation produced by an item to a user's usage behavior and actual energy used by the item. Different protocols may be applied to the same item to derive different environmental conservation values depending on differing regulations, jurisdictions, credit exchanges, etc. Accordingly, one or more protocols can be applied to compute the environmental conservation values of the same item. The protocols used in quantifying and valuating the environmental conservation of an item are derived from a variety of sources including international treaties, municipalities, states, federal governments, quasi-governmental regulatory bodies formed to oversee environmental regulations, or voluntary pacts between participants in the environmental commodities exchange.

When a standard or pre-defined amount of the environmental conservation value is met, either through the environmental conservation value of a single item or through multiple items, some embodiments issue a tradable environmental commodity, such as a Carbon Credit. The commodities can then be bought, sold, and traded within various environmental commodities exchanges (i.e., wholesale market) or sold to the public by means of a retail shopping cart (i.e., retail market).

The value of these issued credits stems from the ability to use the credits to offset certain amounts of pollution resulting from the credit owner's activities, whether manufacturing, transporting, or developing and the offsetting of such activities is recognized within some enforceable regulation. For instance, the Kyoto treaty created caps or quotas for the amount of carbon emissions that various countries can emit. Therefore, when a country exceeds its quota, the country is required to purchase credits to offset the extra amount of pollution generated in excess of the allotted quota. Moreover, some regulations require local utilities to either reduce their emissions production and energy consumption or use green power for a certain percentage of their business related activities. Therefore, some utilities unable to generate the green energy may simply purchase credits that represent certain amounts of generated green energy from others. Other reductions might be voluntary or contractual, based upon a corporate policy or mandate, and subject to legal enforcement. Once such example is found in the membership requirements on the Chicago Climate Exchange that requires members to adhere to scheduled emissions reductions.

Several protocol formulas for computing the environmental conservation value for various environmental conservation items will now be provided. A C.A.F.E. (Corporate Average Fleet/Fuel Economy) protocol may be used by some embodiments to compute the environmental conservation value associated with a vehicle. The formula specifies vehicle fuel savings as the difference between the mileage of the vehicle and the C.A.F.E. value. The computed fuel savings value is then converted into an environmental conservation value (ECV) using a second formula in which:

ECV=Average Annual Mileage of the Vehicle−(Fuel Savings/Product Mileage*C.A.F.E.)*Lbs. of CO2

Some embodiments provide a protocol for determining the environmental conservation value of light bulbs. The protocol converts the emissions savings of an energy efficient light bulb into an environmental conservation value using the following formula:

ECV=(Wattage Equivalence for the Energy Saving Bulb−Actual Wattage)*(Hours per Year)*Lbs of Carbon per Watt associated with a specific power generating facility (utility).

The above examples illustrate the computation of an environmental conservation value using the amount of CO2 reductions as the measurable metric. Emissions of other non-CO2 greenhouse gases can similarly be converted to metric tons of CO2 in order to calculate an environmental conservation value associated with a registered item. A recognized method is to use a CO2 equivalent such as the one hundred year Global Warming Potential (GWP) value as established by the Intergovernmental Panel on Climate Change. The GWP is based on various factors such as a particular heat-absorbing ability of a particular emitting gas also referred to as the radioactive efficiency of the gas. Therefore, protocols of some embodiments can be adapted for computing emissions reductions of credits involving non-CO2 greenhouse gases.

Moreover, it should be apparent to one of ordinary skill in the art that the protocols of some embodiments use various other measurable metrics in computing the environmental conservation value (e.g., kilowatt hours generated from a renewable energy source). It should also be apparent to one of ordinary skill in the art that the protocols of some embodiments can be adapted for computing other emissions reductions, energy savings, reductions in hazardous wastes or materials, and for valuing amounts of generated renewable energy. For example, in order to track and create a rebate for reductions in the hazardous materials of light bulbs such as mercury, some embodiments compute the environmental conservation value associated with the reduction in mercury using the following equation:

$$Mercury Content [ Picograms \text{/} Lumen Hours ] = \\ [ {\sum }_{TypesofBulbs} ( \begin{matrix}Total mercury content \\ per bulb type\end{matrix} ) ] / \\ [ {\sum }_{TypesofBulbs} ( \begin{matrix}Total \\ lumen hours\end{matrix} ) ] * 10 ** 12$$

III. Architecture

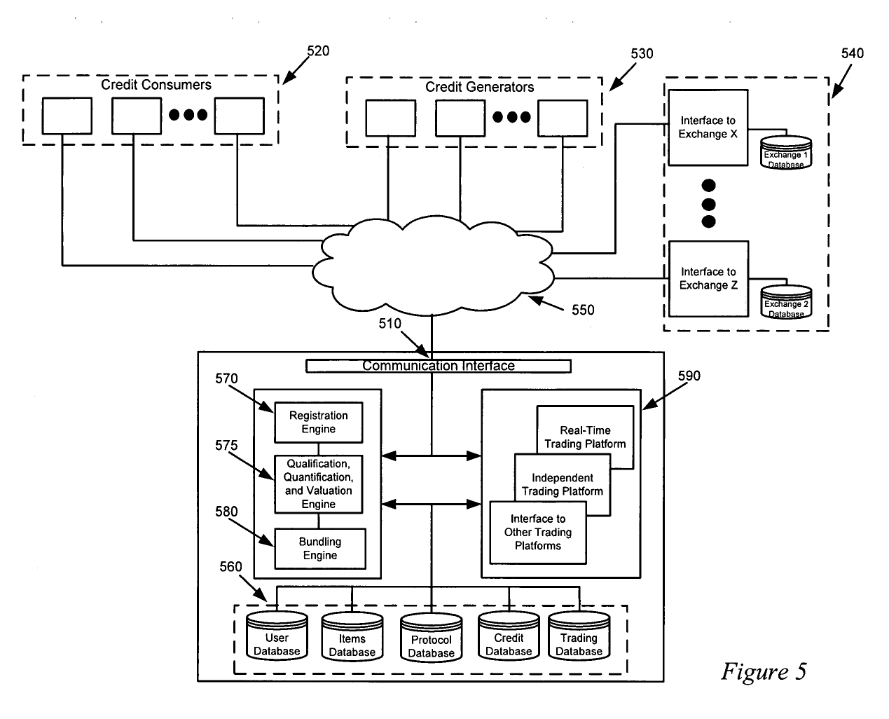

FIG. 5 presents a system architecture used by some embodiments to implement the registration, qualification, quantification, valuation, bundling, and trading functionality. As illustrated in FIG. 5, communications with the system are facilitated through a computer implemented interface 510 in which credit consumers 520, credit generators 530, and other exchanges 540 access the system through a communication medium 550. In some embodiments, the credit consumers 520 and the credit generators 530 include registrants of the environmental conservation items and the buyers and sellers participating within the trading platform. In some embodiments, the credit consumers 520 and credit generators 530 include individual consumers, groups of consumers, businesses, governmental agencies, environmental groups, and other exchanges engaged in environmental commodities trading.

In some embodiments, the communication medium 550 is any network or network of networks through which different devices access the various functionalities provided by the various engines and sub-modules of the engines described below. The communication interfaces for the communication medium 550 include the internet, plain old telephone system (POTS), wireless data services (GPRS), local area network (LAN), wide area network (WAN), or other physical or wireless communication medium. In some embodiments the communication interface 510 is implemented to provide web server functionality via some or all such interfaces. Additionally, the communication interface 510 of some embodiments is implemented using a Service Oriented Architecture (SOA). Using the SOA, some embodiments are capable of processing incoming information through two or more integrated interfaces. These interfaces include other applications, websites, or user interfaces. Additionally, in some embodiments, the various engines (e.g., registration engine, valuation engine, bundling engine, trading engine, or their respective modules) create the interfaces provided to users over the communication interface 510.

In this manner, the architecture of FIG. 5 permits credit consumers 520, credit generators 530, and the other exchanges 540 to be located anywhere throughout the world while still permitting such entities access to the services provided by the system using a variety of different communication devices such as personal digital assistants (PDAs), computers, wireless smartphones, or any internet enabled device. Accordingly, the system interface unifies all entities so that a single entity accessing the system can interact with all other entities accessing the system through a single interface regardless of its physical location throughout the world. For instance, if the entity was a credit generator, then the entity would interact with other credit generators by bundling his items with those of other credit generators.

Some embodiments of the invention store information related to registering, qualifying, quantifying, valuating, bundling, and trading in a set of databases 560. These databases 560 store information such as the available items ready for bundling, the environmental conservation properties of the items, the qualification parameters of the items, the environmental conservation values associated with the items, issued credits, the useful life of the credits, protocols used to value the environmental conservation values of the items, or general user access information as some examples. One of ordinary skill in the art will recognize that some embodiments of the invention include some, all, or additional databases 560 for storing information pertaining to the functionality provided by the system. Additionally, though the databases 560 have been shown as multiple databases, one of ordinary skill in the art will recognize that the multiple representations can be a conceptual representation and that the actual physical implementation may be conducted through a single database. The system also includes logic for querying, storing, and retrieving information from such storage locations 560 and for presenting the information through the interface 510 to the users.

Functionality within the system is provided via the various functional engines. In FIG. 5, the system includes a registration engine 570, a qualification, quantification, and valuation engine 575, a bundling engine 580, and a trading engine 590. In some embodiments, one or more of the engines represents software processes executed by a processor of a computing device. In other embodiments, one or more of the engines represents physical hardware devices that implement the functionality described herein. It should be apparent to one of ordinary skill in the art that the various other functional modules may similarly be incorporated within the overall system.

The registration engine 570 implements the interface through which environmental conservation items are registered and administrative functionality pertaining to the management of a user account is performed (e.g., disbursing of payments and tracking of registered items). The registration engine 570 is described in further detail in Section IV below. The valuation engine 575 determines an amount of environmental conservation associated with the use or application of an environmental conservation item. The functionality for the valuation engine 575 is described in further detail in the United States Patent Application titled “System and Method for Valuating Items as Tradable Environmental Commodities” with attorney docket EQDX.P0006 which is incorporated herein by reference. The bundling engine 580 provides the bundling and unbundling of fractional credits, buyers, and sellers and is described in further detail in the United States Patent Application titled “A Bundling Method and System For Credits of an Environmental Commodities Exchange” with attorney docket EQDX.P0010 which is incorporated herein by reference. The trading engine 590 provides the trading platform over which credits are bought, sold, and traded. The trading engine 590 is described in further detail in Section V below.

IV. Registration

The communication interface 510 of FIG. 5 is a computer implemented interface or some other electronic interface. When a user initially accesses the system, the registration engine presents to users an initial registration interface through the communication interface 510.

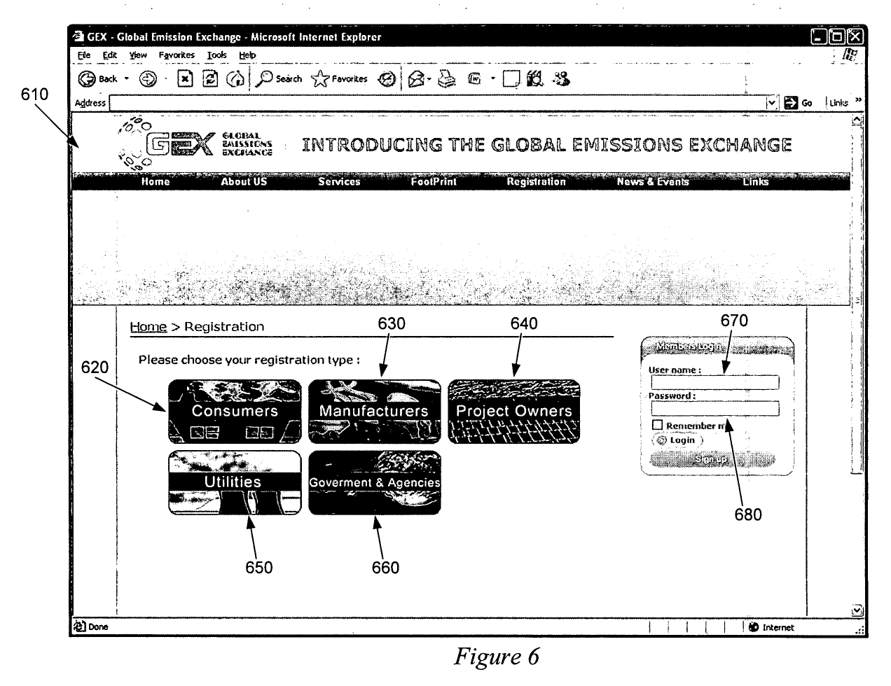

FIG. 6 illustrates an initial registration interface 610 from which users select a registration type 620-660 that classifies the user in order to provide subsequent interfaces based on the functionality associated with the user classification. In this figure, the registration interface 610 includes the following classification types: consumers 620, manufacturers 630, project owners 640, utilities 650, and government agencies 660. Once classified, the registration interface changes to allow the user to access the various functional modules of the registration engine according to the user classification. A Rule Engine monitors user types, associates preset features and automatically presents available functions to the user. Users already registered need only reenter identification information such as a username 670 and password 680 to access the functionality corresponding to their previously registered classification type. The description below further details the registration functionality provided to consumers and manufacturers.

A. Consumer Registration

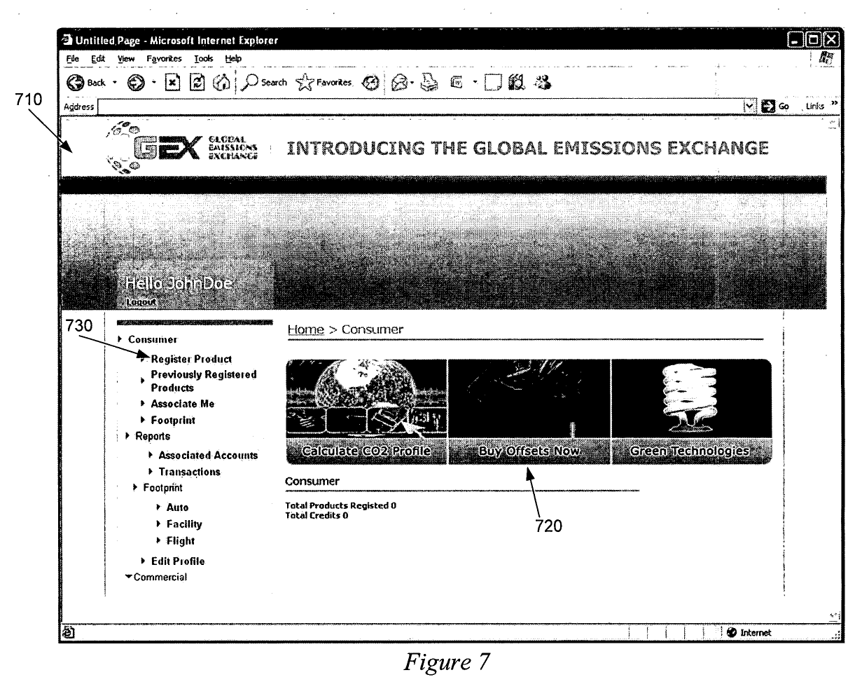

FIG. 7 presents an illustrative interface 710 presented to a user classified as a consumer. From the interface 710, the user is able to purchase credits to offset a polluting activity or to reduce the user's emissions footprint using the selectable graphical representation 720. The user is also able to register new items by selecting the graphical link 730. Registering new items provides users with the benefit associated with the environmental conservation resulting from the use or application of the item.

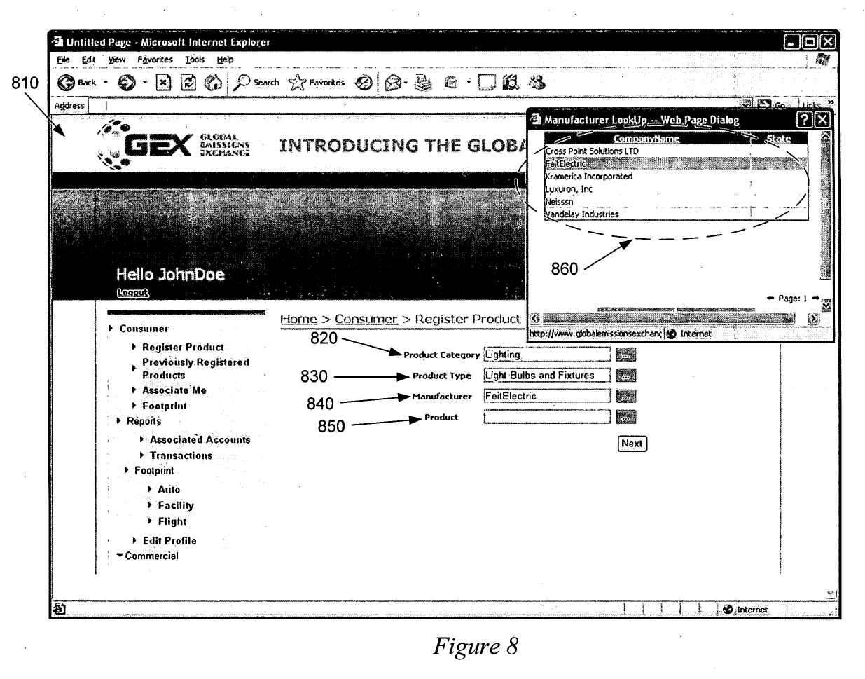

FIG. 8 illustrates an interface 810 presented to a user registering one or more environmental conservation items. In this figure, the user is provided a computer implemented interface that includes interactive user interface fields 820-850 for entering at least one parameter that identify the environmental conservation item to be registered. As shown, some embodiments identify the different items by requiring the user to specify the item category 820, the item type 830, the manufacturer of the item 840, and the particular item 850. Some embodiments provide a window 860 with a set of selectable listings of the valid entries for a given data field 820-850.

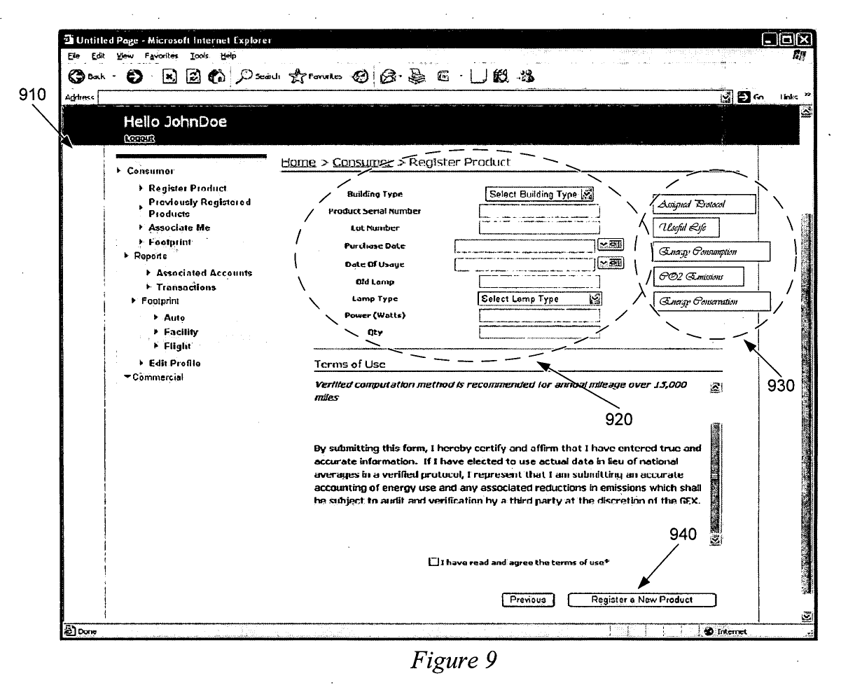

In order to quantify an amount of environmental conservation associated with the item being registered, some embodiments require additional information relating to environmental conservation properties of the item. FIG. 9 presents an illustrative interface 910 for specifying environmental conservation properties for an item. In this figure, the user specifies a set of qualification parameters that modify the later computed amount of environmental conservation by the actual use of the item by the user. For instance, fields 920 specify properties for the previous analog item which is replaced by the newer environmental conservation item. Therefore, a user replacing an energy efficient light bulb with another energy efficient light bulb is not generating any form of environmental conservation that previously did not exist. However, a user replacing an inefficient incandescent light bulb with a newer energy efficient compact fluorescent light is directly reducing his/her environmental footprint by consuming less energy. By consuming less energy, the user causes less energy to be generated and thus fewer pollutants that result from the energy generation to be emitted. As such, the amount of environmental conservation associated with each item is unique based on these and other qualification parameters.

Additionally, in some embodiments, the interface 910 automatically populates fields 930 based on the identification information provided in FIG. 8 above. The fields 930 specify environmental conservation properties associated with the item being registered. Therefore, after identifying the item as a particular energy efficient light bulb by a particular manufacturer some embodiments retrieve environmental conservation properties for that particular light bulb from an items database. Specifically, fields 930 include information such as the amount of energy consumed, the expected lifetime of the item, the amount of carbon emissions produced over the expected lifetime, the protocol to be used to compute the environmental conservation value of the item, and the efficiency of the item in comparison to previously existing analogs. Some or all such parameters may exceed a common user's scope of knowledge. However, by maintaining a database with which to automatically populate the fields 930, some embodiments reduce the amount of the information that a user needs in order to register an item.

After fields 920 and 930 contain the information necessary for registering an environmental conservation item, the registrant may use the selectable links 940 to add/register the item. Some embodiments then compute an actual amount of environmental conservation resulting from the qualification parameters 920 and the environmental conservation parameters 930 of the item.

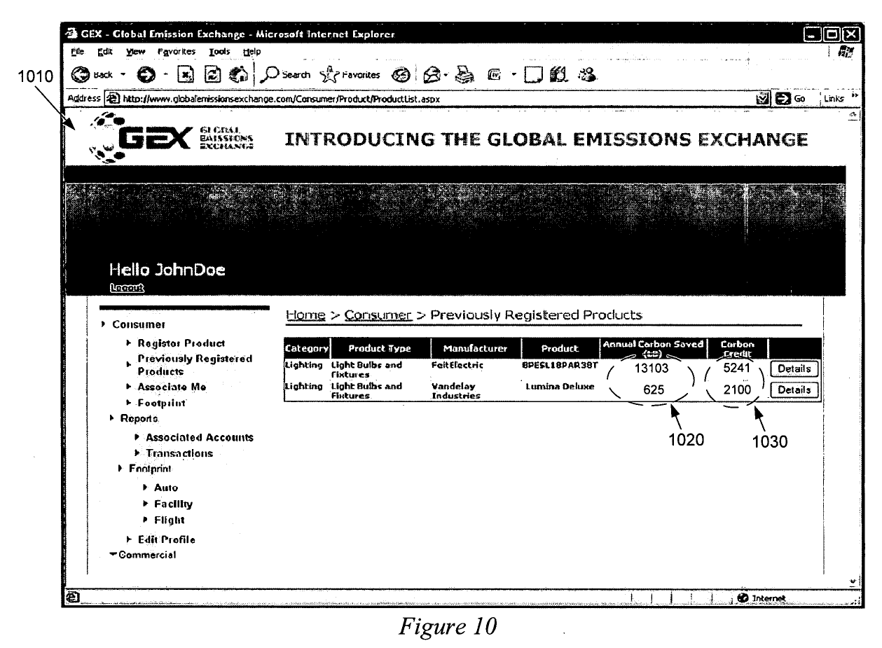

FIG. 10 presents an illustrative interface 1010 showing the computed amount of environmental conservation resulting from one or more registered items. Specifically, the interface 1010 displays the computed amount of carbon dioxide savings 1020 resulting from the user's particular use or application of the item. The interface 1010 also displays the quantified environmental conservation value for each item 1030 resulting from the computed amount of environmental savings 1020 of the item. The quantified environmental conservation value of FIG. 10 represents amounts of reduced emissions needed to issue a tradable environmental commodity, such as a Carbon Credit. The environmental conservation value is used to provide a compensable amount to the user in proportion to the amount of registered environmental conservation. Additionally, some embodiments issue certificates to the users to certify the registered amount of conservation by each user. The certificates may include electronic certificates issued over the registration interface or physical certificates delivered to each user.

Compensation in some embodiments includes distribution of a monetary sum or a rebate. Users may specify the distribution scheme for their compensation. For example, compensation may be directly distributed via a check to the last known address of the registrant. Alternatively, compensation can be directly transferred via a wire transfer to the user's bank account. Moreover, the user can specify when to receive the compensation. Rather than issue payment after registration of each item, some embodiments allow distribution of the payment to occur upon a specified event, such as when the total amount of payment is greater than or equal to some amount. Furthermore, some users may specify that the compensable sum go to some other entity. In this manner, the amounts may directly fund a charitable organization that the user deems worthy.

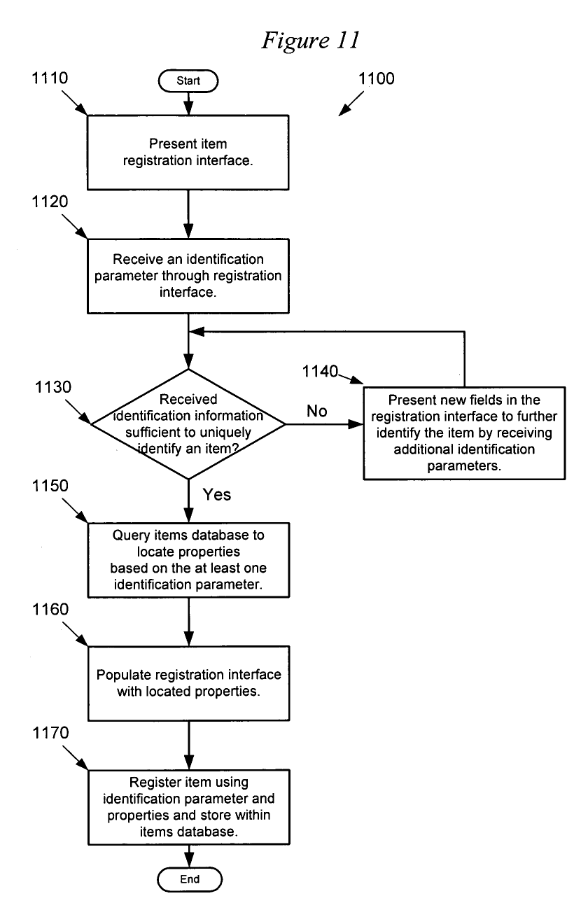

FIG. 11 presents a process 1100 that conceptually illustrates several operations performed by the registration engine for registering an environmental conservation item. The process 1100 begins by presenting (at 1110) a registration interface to a user. The registration interface may resemble one or more of the interfaces 610-910 illustrated above or alternative interfaces for receiving input from a user. Through the one or more registration interfaces, the process receives (at 1120) at least a first identification parameter as input from the user. The process verifies the received input to determine (at 1130) whether additional parameters are required to uniquely identify the item. This determination can be made after the user completes an input within the identification fields or upon a stated event such as when the user clicks on a selectable item within the registration interface. If the item cannot be identified based on the first identification parameter alone, the process receives (at 1140) further input from the user by presenting to the user one or more additional registration interfaces.

As described above, the registration interface need not be a static interface but may include a dynamic interface that changes in response to input from a user. For example, if a first identification field specifies an automobile as the item to be registered, then a second set of fields pertaining to automobile registration may be presented to the user. The second set of fields may include a selectable list of automobile manufacturers from which the user may select. Once the second field is selected, then a third set of fields may be presented and populated to specify the vehicle make or other identification parameters. Alternatively, if the first identification field specifies an energy efficient light bulb as the item to be registered, then the second set of fields may become populated with a selectable list of energy efficient light bulb manufacturer's from which the user may select, as show in FIG. 8.

Once the item is uniquely identified at 1130, the process searches (at 1150) an items database to locate a set of environmental conservation properties associated with the item. The set of properties can be entered by manufacturers prior to releasing an environmental conservation item into the marketplace. Since the manufacturers create or produce such environmental conservation items, the manufacturers are best able to enumerate the environmental conservation properties of the item. Therefore, the manufacturers create entries for the items and the associated environmental conservation properties.

The manufacturers need only register the environmental conservation properties for each item only once. Thereafter, each consumer who purchases or uses the environmental conservation items need not individually enumerate such properties when registering the items. Rather, each consumer simply identifies the item and the set of properties are automatically associated with the item. A more detailed discussion for manufacturer registration is described in detail in Subsection B) below.

After locating the set of properties from the pre-populated entries within the items database, the process populates (at 1160) the set of properties within the registration interface. As different items include various environmental conservation properties, it should be apparent to one of ordinary skill in the art that the fields within the registration interface are dynamic and are presented in accordance with the located set of properties. Alternatively, some embodiments permit the user to adjust, add, or specify the properties.

At this stage the registration interface contains sufficient information by which to register an item and associate the registered entry to the user. Therefore, the process registers (at 1170) the item and user information and the process terminates. The information is stored within the items database for subsequent access by the user. Additionally, the user may be compensated for the amount of registered environmental conservation.

Registration is further automated in some embodiments by automatically retrieving the identification information necessary for registering an item at the time of the item's purchase. To facilitate the direct registration of items, some embodiments directly interface with one or more retailers that sell the environmental conservation items. Therefore, when a consumer passes through a register of the retailer and the item is scanned, some embodiments automatedly retrieve the scanned information in order to register the environmental conservation associated with the item. The scanned data provides the necessary identification information, such as the make and model of the item from which some embodiments identify the environmental conservation properties and the one or more protocols needed to quantify the environmental conservation of the item. Moreover, some embodiments can directly register the item on behalf of the consumer using such a process. Specifically, when a consumer swipes a credit card to pay for the purchase at the retailer, some embodiments are able to identify the consumer based on the credit card data and therefore register the item on the consumer's behalf. The benefit of the registered environmental conservation (i.e., monetary compensation related to the amount of environmental conservation) can then directly be disbursed to the consumer's credit card in seamless and fully automated fashion.

It should be recognized by one of ordinary skill in the art that the process 1100 of FIG. 11 can be adapted to register environmental conservation items including different products, projects, or technologies that bestow different types of environmental conservation. For example, some environmental conservation projects include landfill remediation, sewage treatment facilities, waste management facilities, wastewater treatment facilities, agriculture operators through carbon sequestration, solar farms, wind farms, hydroelectric power plants, geothermal power plants, tidal power plants, synthetic fuel producers to name a few. These projects may further be divided into pollution abatement projects such as wastewater treatment and animal waste processing and clean power generation or renewable energy projects such as solar farms and wind farms.

Some embodiments facilitate report generation based on the item registration. The reports can be custom generated to provide pertinent and hierarchical information to any enterprise, allowing the enterprise to analyze the effectiveness of one or more environmental policies of the enterprise.

A large enterprise includes various departments and individuals within each department. Each department may receive different environmental policy requirements. By using the registration functionality provided by some embodiments, each department or individual within the department registers their environmental conservation separately. The data from all departments or individuals within the departments can be automatically aggregated and parsed to generate specific reports such that the effectiveness of each policy can be measured within different hierarchical levels of the enterprise.

For example, a federal mandate may require individual states to reduce their carbon footprint by 5%. Each state may allocate disproportionate amounts of carbon reductions to different cities within its jurisdictions. Similarly, each city may allocate disproportionate amounts of carbon reductions to different municipalities within the city's jurisdiction. If all such entities register their environmental conservation using the registration functionality provided by some embodiments, the federal government will be able to view the amount of carbon reductions per state, per city, and per municipalities. States will be able to view the amount of carbon reductions per city and per municipalities while also being able to compare their effectiveness with respect to other states. Accordingly, the registration functionality provided by some embodiments facilitates monitoring of environmental policies and regulations by providing a central reporting mechanism that gathers and reports the data from multiple different sources.

In some embodiments, the functionality of the registration engine is extended to facilitate environmental conservation even before items are purchased. To do so, some embodiments allow users the ability to access the registration interface in order to receive a listing of various items that assist in reducing the user's environmental impact. For instance, the user registers the lights bulbs currently in use in the user's home. Based on this information, the registration engine queries the items database to identify functionally equivalent but more environmentally friendly replacement items. Moreover, some embodiments allow links to the items such that the user can directly purchase the item and immediately receive the environmental conservation benefit resulting from the efficiency gains. Accordingly, when the user purchases the more environmentally friendly item, the item is automatically registered on behalf of the user as all necessary registration information is available to the registration engine. It should be apparent to one of ordinary skill in the art that additional information may be required to facilitate the registration of the newly purchased item.

B. Manufacturer Registration

As described above, some embodiments simplify the consumer registration process by allowing manufacturers of the environmental conservation items to pre-populate the items database with the items and the associated environmental conservation properties needed to quantify an amount of environmental conservation resulting from the use or application of each item. This allows those most familiar with the items (i.e., the manufacturers of the items) to provide the detailed information necessary for converting the item into a tradable environmental credit. Moreover, the removal of the overhead associated with the additional registration information permits consumers without an expansive knowledge of the workings of the item, the ability to quickly register items using only a minimal set of identification parameters.

In other exchanges, registration for an energy efficient light bulb requires the registrant to identify the item by entering the make and model of the item, but also to specify properties of the item such as the luminance, average life cycle, expected kilowatt hours used over the life cycle, material composition, etc. associated with the light bulb. Moreover, in such exchanges, the registrant must also define the protocol that computes an amount of environmental conservation associated with the item based on its environmental conservation properties. Some such information is ordinarily not within the common knowledge of a consumer. As such, consumers are often dissuaded or prevented from participating in the environmental commodities exchange.

As described in the registration section above, some embodiments simplify registration for a consumer by automatically populating the environmental conservation properties and protocols needed to quantify an amount of environmental conservation associated with an item. Such information is previously supplied by the manufacturers of the items. Therefore, the complexities and knowledge requirements for registering an environmental conservation item are minimized and the entire process is streamlined for the consumer registrant. Accordingly, the consumer registrant need only specify a few basic identification parameters in order to participate in and receive benefit from the environmental commodities exchange.

Some embodiments facilitate manufacturer registration using the same or similar electronic interface (e.g., an internet accessible webpage) provided for consumer registration. Manufacturers gain access to the registration interface by providing a username, password, and proper classification (i.e., manufacturer) through an initial registration interface.

Once identified by the system, the manufacturers can specify their desire to enter new environmental conservation item information into the items database by clicking a selectable link to navigate through the various functionalities. Some embodiments then update the interface window to display a registration interface whereby new item entries are defined by manufacturers.

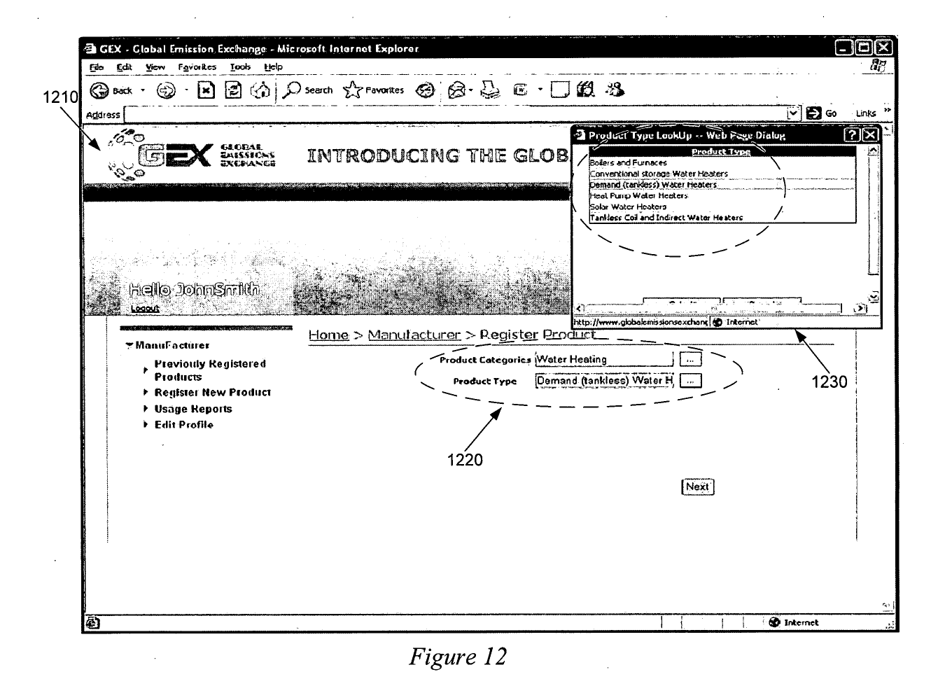

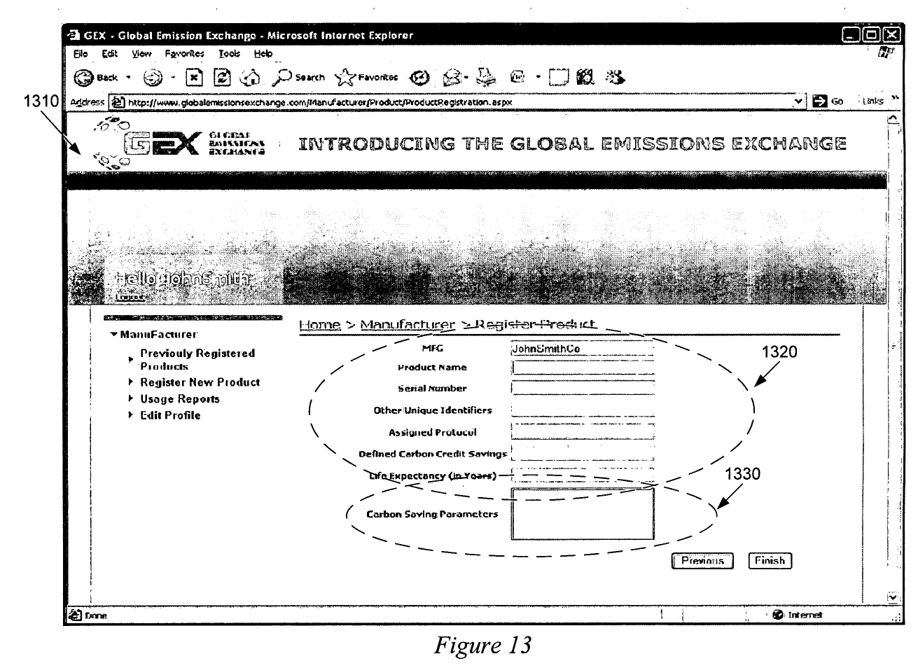

FIG. 12 presents an illustrative interface 1210 for a manufacturer defining new environmental conservation items into an items database in accordance with some embodiments of the invention. Using the interface 1210, the manufacturer specifies the categories and type 1220 for the item from a selectable list of parameters 1230. Then, using the illustrative interface 1310 of FIG. 13, the manufacturer defines additional properties 1320 and the protocol 1330 that specifies the heuristics for converting the environmental conservation properties of the item into a quantifiable amount of environmental conservation.

It should be apparent to one of ordinary skill in the art that in some embodiments the manufacturer may not have pre-populated the items database at the time of consumer registration. In some such embodiments, the registrant continues to only provide the unique item identification parameters. Some embodiments then contact the manufacturer to acquire the remaining information necessary for determining the environmental conservation properties of the item.

In some such embodiments, the items database can directly interface with a manufacturer's proprietary items database through an import interface of the system. The import interface allows a direct transfer of information from the manufacturer's proprietary system into the items database of some embodiments. The direct transfer can be established over an electronic interface using standard messaging functions or file formats. For instance, a comma delimited file (.csv) or an extensible markup language (XML) file containing item information (e.g., environmental conservation properties, protocols, etc.) can be directly uploaded from the manufacturer's database into the items database of some embodiments. After uploading, some embodiments parse the relevant data to update the items database. In this manner, the manufacturer provides access to its database; however, the manufacturer does not directly interact with the registration system provided by some embodiments. Therefore, when an update is made at the manufacturer site, the items database can be automatically updated to reflect the changes. It should be apparent to one of ordinary skill in the art that the direct transfer need not occur directly with the manufacturer's database. For example, some embodiments may establish the direct transfer with a governmental agency that maintains a database of information pertaining to commercially sold items.

C. Manufacturer Proxy Registration

In addition to permitting manufacturers the ability to define items within the items database, some embodiments further permit the manufacturers the ability to register environmental conservation items and receive the compensable amount derived from the environmental conservation value associated with the registered items. Such registration is referred to in some embodiments as proxy registration. Proxy registration includes registration of items purchased by a manufacturer for a consumer or a corporation. An example of proxy registration includes leasing of environmental conservation items to a consumer. Therein, the manufacturer or leasee retains ownership over the items and therefore the manufacturer may perform registration on behalf of the leasors.

It should be apparent to one of ordinary skill in the art that though the terms registration and registrant are used with reference to consumers and manufacturers, the terms connote different aspects of the invention when applied to consumers and when applied to manufactures. Specifically, manufacturer registration permits manufacturers and other non-consumers producing the environmental conservation items the ability to update the items database to specify environmental conservation properties for a newly generated item and other identification information. Moreover, manufacturers can update information pertaining to already registered items or specify alternative means by which to identify the already existing items, such as specifying new categories for grouping items within the items database. However, manufacturers are unable to register the actual environmental conservation associated with use of an item unless the manufacturer itself becomes a consumer and purchases such items for its own use or leases the items to other entities and registers the savings using the proxy registration described above.

V. Trading Platform

Some embodiments provide a trading engine that facilitates the buying, selling, and trading of credits through a trading interface. Through the trading interface, users can make their credits available to a potential pool of buyers by placing their credits onto a trading platform while sellers can search through and purchase various types of credits that meet various criteria.

A. Directly Interfaced Trading Engine

To implement the trading engine, some embodiments leverage the existing trading platforms of other exchanges. In some such embodiments, when a credit is issued or registered, the trading engine directly places the credits onto the trading platforms of the other exchanges so that such credits can be sold and traded therein. In this manner, a participant in the environmental commodities exchange of some embodiments gains access to the existing pool of members of the other exchanges (e.g., members who are buyers of credits). Moreover, a credit can be placed on multiple trading platforms to increase the potential pool of buyers and to increase the likelihood of the credit being sold or traded. In some embodiments, users select the multiple trading platforms on which to place the credit. Once the credit is sold on one of the trading platforms, the credit is removed from all other trading platforms. In conjunction with or instead of allowing the user to select the trading platform, some embodiments automatically select the trading platform/s that best suits the credit at issue.

The directly interfaced trading engine of some embodiments allows for credits of different types to be registered in a single location and placed on one or more different trading platforms to be sold or traded thereafter. In this manner, the owner or registrant of such credits need not become a member of each and every exchange on which he wishes to participant in. Rather, the user registers with some embodiments of the invention and from this single interface, the user gains access to some or all the trading platforms of the other exchanges. Such functionality similarly extends to users acting as credit consumers wishing to buy credits placed onto the trading platforms of other exchanges by members of those exchanges.

Access to the other exchanges is provided by some embodiments of the trading engine which acts on behalf of the users. As such, users do not have to learn the different functionality, rules, or interfaces of the various other exchanges. Instead, using a single interface provided by some embodiments, buyers and sellers are able to interact and perform trading operations on any number of environmental commodities exchanges. The interface provided by some embodiments performs the necessary conversions needed to execute the operations on the other exchanges.

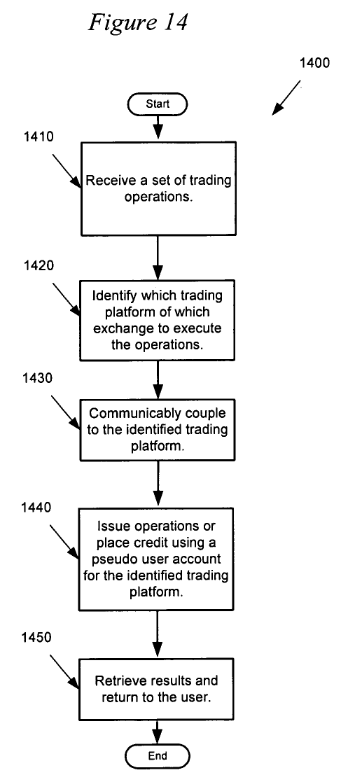

FIG. 14 presents a process 1400 that conceptually illustrates several operations performed for implementing the functionality of an exemplary trading platform in accordance with some embodiments of the invention. The process 1400 begins by receiving (at 1410) a set of trading operations that a user desires to perform on one or more different exchanges. For example, the operations may specify a sell order for a credit within the user's possession or operations to purchase one or more credits listed on one or more different exchanges. The process then identifies (at 1420) at least one trading platform on which to execute the set of trading instructions. The at least one trading platform is specified by the user or is automatically selected based on some predetermined set of criteria. Examples of some predetermined set of criteria include selecting the trading platform with the most buyers or the trading platform that averages the highest sell price for a credit.

In order to interface with the at least one trading platform of one different exchange, the process communicably couples (at 1430) with the trading platform over an electronic interface. The electronic interface provides access into the trading databases of the other exchanges. It is through this electronic interface that some embodiments issue the trading operations or place credits onto the trading platforms of the other exchanges. The electronic interface of some embodiments may be implemented via the TCP/IP protocols used over the public internet or through some other electronic communication protocol.

Through the electronic interface, some embodiments are able to emulate members of the other exchanges and perform operations that such members would be able to perform. Thus, some embodiments create pseudo user accounts within each communicably coupled exchange. The pseudo user accounts provide some embodiments with a similar set of functionality as that afforded to actual members of the other exchanges. Such functionality allows the process to issue (at 1440) the trading operations (e.g., place, buy, sell, and trade credits) on the trading platforms of the other exchanges as if executed by an actual member. To do so, some embodiments translate the received user operations at 1410 to the corresponding set of operations recognized by the destination trading platform.

By using the pseudo user account, some embodiments perform operations on behalf of one or more users without requiring each such user to have to register with each of the other exchanges or become familiar with the interfaces and commands of each such exchange. For example, two users specify trading operations to perform a particular trading platform of some other exchange. The trading operations are received through the trading interface provided by the trading engine of some embodiments. The trading engine of some embodiments then interfaces with the trading platform of the other exchange through the pseudo user account. The trading operations of both users are communicated using the pseudo user account to the other exchange over the electronic interface. The other exchange processes the actions as if they originated from a common entity (i.e., the pseudo user account), even though the common entity in this case acts on behalf of two different users or separate entities. The process then retrieves (at 1450) results. The results are returned to the corresponding users and the process ends.

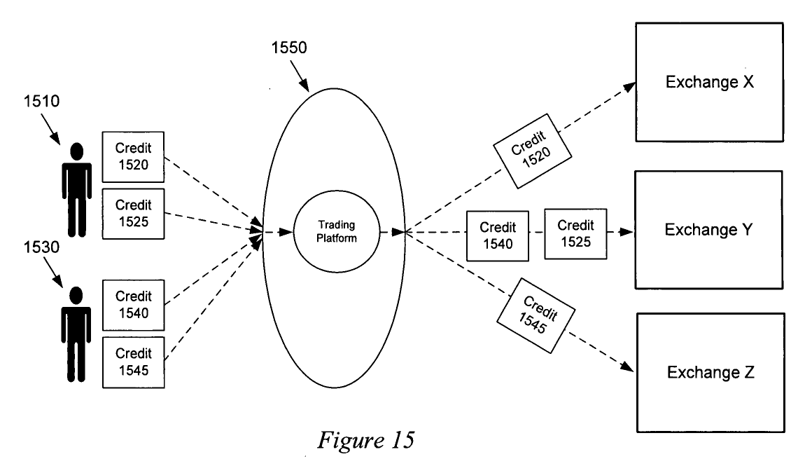

FIG. 15 illustrates how some embodiments directly interface with the trading platforms of other exchanges through a communicably coupled interface. In FIG. 15, user 1510 registers his two available credits 1520 and 1525 through the electronic interface of some embodiments of the trading engine 1550. Similarly, user 1530 registers his two available credits 1540 and 1545 through the electronic interface of the trading engine 1550.

User 1510 then specifies which trading platforms his credits 1520 and 1525 should be placed onto for trading. In this figure, user 1510 has specified placing credit 1520 onto the trading platform of Exchange X and credit 1525 onto the trading platform of Exchange Y. User 1530 however does not specify which trading platforms his credits 1540 and 1545 should be placed on, therefore some embodiments automatically route the credits based on some specified criteria. In this figure, credit 1530 is automatically routed to the trading platform of Exchange Y and the credit 1545 of user 1530 is automatically routed to the trading platform of Exchange Z.

When such credits are placed on the trading platforms of Exchange X, Y, and Z, the credits are represented as belonging to some pseudo entity originating from the trading platform of the exchange 1550. As discussed above, this is because the interaction with the other exchanges is conducted through an emulated user account where some embodiments of the trading engine 1550 act as a member of the other exchanges. All operations specified by users 1510 and 1530 are performed by the pseudo user account of the trading interface of the trading engine 1550 on behalf of the users. Therefore, once the credit 1520 is placed onto the trading platform of Exchange X and credit 1525 is placed onto the trading platform of Exchange Y, the selling entity for both credits in both exchanges is represented as the pseudo user account of the exchange 1550. In this manner, it is irrelevant whether user 1510 is a member of Exchange X or Exchange Y so long as user 1510 is registered with the trading engine of some embodiments 1550. Similarly, it is irrelevant whether user 1530 is a member of Exchange Y or Exchange Z so long as user 1530 is registered with the trading engine of some embodiments 1550.

If any of the credits 1520-1525 and 1540-45 are sold or traded, the compensation given in exchange for the credits is returned to exchange 1550 via the emulated user account. The compensation is then routed to the proper user.

B. Unified Trading Engine

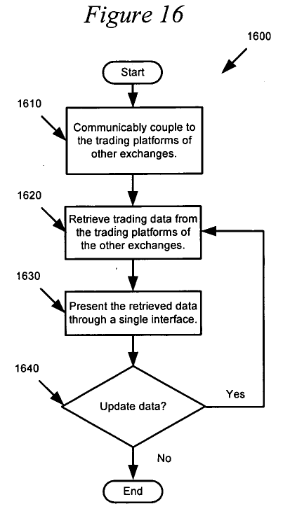

FIG. 16 presents a process 1600 that conceptually illustrates several operations performed by the trading engine to leverage the trading platforms of other exchanges by unifying and presenting the trading data of such exchanges into a single interface that is accessible through an electronic interface. The process 1600 begins when the trading interface establishes (at 1610) a communicably coupled interface to the other exchanges. Through the communicably couple interface, the process accesses and retrieves (at 1620) the trading data from the trading platforms of such exchanges. In some such embodiments, the trading data is retrieved in real- time as the data is updated within the corresponding trading platform. The data from the different trading platforms is then combined and presented (at 1630) through the trading interface provided by the trading engine of some embodiments.

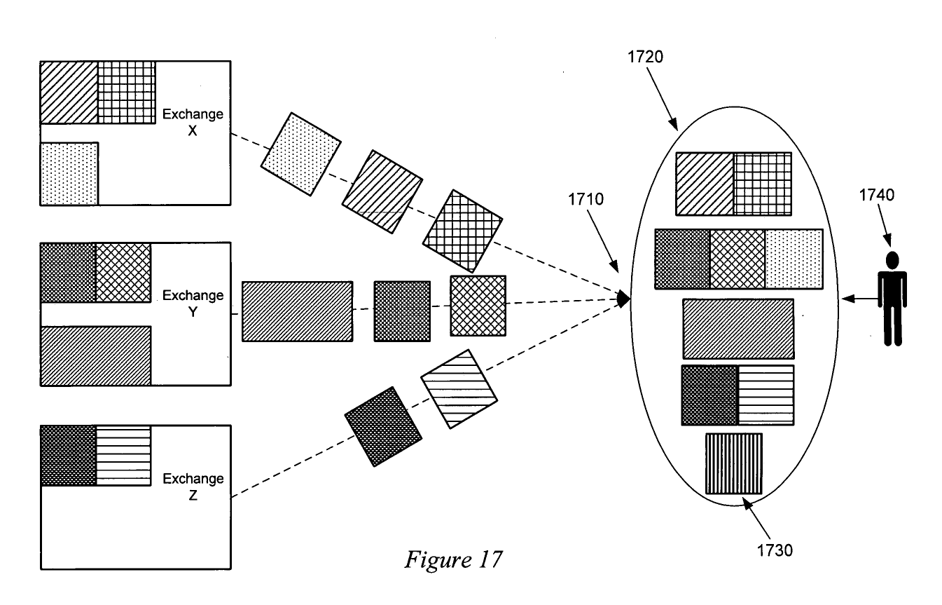

FIG. 17 conceptually illustrates how some embodiments of the invention create the unified trading interface that includes the credits of the various other exchanges. In FIG. 17, the credits from Exchanges X, Y, and Z are retrieved through the communicably coupled interface 1710. To retrieve the data, some embodiments establish access to the databases of the trading platforms of the other exchanges. The retrieved credits are combined and presented within the single trading interface 1720. However, one of ordinary skill in the art should recognize that the trading interface 1720 may also include credits that have been internally issued using the bundling procedure described above. Therefore, when the user 1740 accesses the trading interface 1720, the user is presented with some or all the available credits currently trading within trading platforms of Exchange X, Y, and Z and those credits internally issued within a trading platform of the exchange system (e.g., the credit 1730).

Referring back to FIG. 16, a determination is made (at 1640) as to whether the trading data needs to be updated after it has been retrieved and presented within the unified interface provided by some embodiments. In some embodiments, the trading data is constantly updated when the trading data represents a real-time portrayal of the trading data on the trading platforms of the other exchanges. In some embodiments, the trading data can be updated in response to a specific event such as the buying, selling, trading, or modification of a credit on any of the trading platforms of the other exchanges. In either case, the process returns to step 1620 where the data is continually retrieved from the various trading platforms to be displayed in the unified display interface provided by some embodiments. If the data is not updated, then the process ends.

Accordingly, credit buyers accessing the trading interface of some embodiments are provided access to a larger pool of available credits, because they can simultaneously view and purchase the available credits on multiple different exchanges. Moreover, the users can selectively view specific types of credits if the credits of the other exchanges represent different types of environmental conservation or different amounts of environmental conservation (i.e., one ton worth of carbon emissions).

Some embodiments allow users the ability to select and view only the credits of specified trading platforms based on some user-specified criteria. For example, a user may specify to view only credits that may be used to offset sulfur dioxide emissions as opposed to some other kind of emission. Furthermore, since the environmental commodities of different jurisdictions may conform to different regulations, some embodiments provide a single trading interface that allows credits to be sorted and viewed by jurisdiction. Therefore, some embodiments of the trading interface organize and sort the retrieved set of credits according to certain specifications of the credits.

Similar to FIG. 14, when a command or trading operation is specified for a credit residing on the trading platform of a different exchange, the operation will be received from the user through the trading engine interface of some embodiments. The trading operation will then be transmitted and executed on the trading platform of the other exchange on behalf of the user using an emulated user account. In this manner, a buyer can access the unified trading interface of some embodiments and view the credits from multiple trading platforms of multiple different exchanges. If the buyer places a purchase order for two credits that were retrieved from two separate trading platforms of different exchanges, the buyer need only be familiar with the single unified trading interface provided by some embodiments. The purchase order will then be translated and communicated in a manner according to the specifications of each particular exchange. The buyer is thus removed from having to become familiar with or become knowledgeable of the interfaces specific to each particular exchange. Similarly, the buyer need not become a member of each exchange in which he participates, because the trading engine of some embodiments acts on the user's behalf through the above mentioned pseudo user account.

C. Independent Trading Platform

Some embodiments of the trading interface are coupled to a proprietary trading platform that operates independently of the other exchanges. In this manner, credits that have issued using protocols not approved by other exchanges, but approved within some embodiments are therefore provided a trading platform. Moreover, credits retrieved from the trading platforms of other exchanges can be placed for buying, selling, and trading on the independent trading platform provided by some embodiments of the trading engine.

The trading platform allows for a credit issued from an embodiment of the invention or a credit issued from other recognized exchanges to be simultaneously placed within the trading platform of some embodiments of the invention. Any user registered with the system is therefore permitted access to purchase and trade credits through the trading interface without having to be a member of the other recognized exchanges. Additionally, credits that have been issued through protocols that were not approved or are pending approval by other exchanges may still be sold and traded.

Some embodiments also have the capability of performing as a clearing platform. As such, for electric, gas, water, and other utilities that may have regulatory requirements or that distribute rebates for energy savings products, some embodiments of the invention can provide the mechanism to register and track energy saving purchases by consumers.

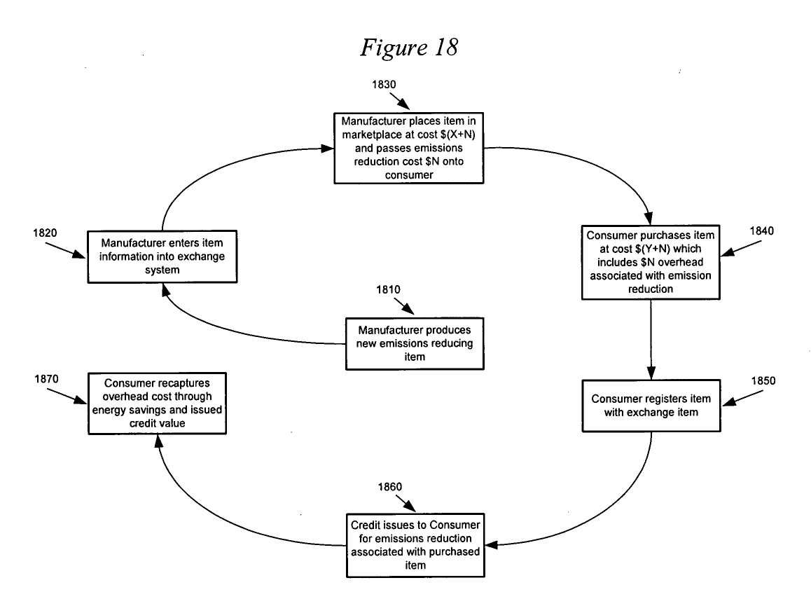

By providing a computer implemented trading platform in conjunction with the registration, qualification, quantification, valuation, and bundling functionality, some embodiments of the invention provide incentive for and facilitate the adoption of environmentally friendly products and business practices. FIG. 18 conceptually illustrates how some embodiments facilitate the adoption through a series of cost offsets.

The cycle begins at 1810 when a manufacturer produces some new environmental conservation item. Typically, the cost of producing such an item is relatively more costly than producing the equivalent non-environmental conservation analog. The additional manufacturing overhead costs typically are the result of incorporating newer and more efficient technology as one example. However, one of ordinary skill in the art will recognize that other sources such as the additional cost associated with using more efficient machinery to assemble the product can similarly contribute to the added overhead costs.

Once produced, the manufacturer enters (at 1820) information about the item with some embodiments of the exchange system so that consumers can easily locate and register their purchased items. Moreover, the manufacturer places (at 1830) the item into the marketplace with the additional overhead cost associated with the environmental conservation properties of the item being reflected in the purchase price of the item. In this manner, the manufacturer has passed the overhead cost to the consumer.

The consumer has the option of purchasing the environmental conserving item or its non-environmental conserving analog. Should the consumer purchase (at 1840) the environmental conserving item, it is likely that the consumer pays the overhead associated with the environmental conserving properties of the item. However, because the consumer can register (at 1850) the item within some embodiments of the invention and receive (at 1860) the value associated with a portion of a credit issued as a result of the environmental conservation properties associated with the item, the consumer is able to recuperate (at 1870) some of the overhead cost paid to acquire the item. The issued tradable commodities are then purchased by entities needing to offset their polluting or other non-environmentally friendly practices. The cost to purchase such commodities, in some instances, represents the initial overhead cost associated with creating the environmental conservation item.

As a result, environmental conservation items are introduced, purchased, and used in the marketplace and the cost associated with designing, creating, manufacturing, and purchasing such items is minimized as this overhead cost is passed from the environmentally friendly manufacturer, to the consumer, to other non-environmentally friendly entities needing to purchase credits to offset their polluting activities. This further provides an incentive for the non-environmentally friendly entities to change their business practices and to instead produce, use, or create more environmentally friendly items and practices in order to reduce their cost for having to purchase such credits. Therefore, some embodiments of the invention directly result in decreasing the environmental footprint left by such entities (e.g., manufacturers, consumers, etc.).

VI. Computer System

Many of the above-described engines, modules, and processes are implemented as software processes that are specified as a set of instructions recorded on a machine readable medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention.

In some embodiments, the various engines and modules described herein represent physical hardware devices that implement the functionality associated with each of the enumerated engines, modules, and processes. It should therefore be apparent to one of ordinary skill in the art that some such engines, modules, or processes are conceptually illustrated as automated machine processes executed without user interaction. However, in some embodiments, some such engines, modules, or processes may be different technical implementations such that they are implemented using a combination of automated and manual processes.

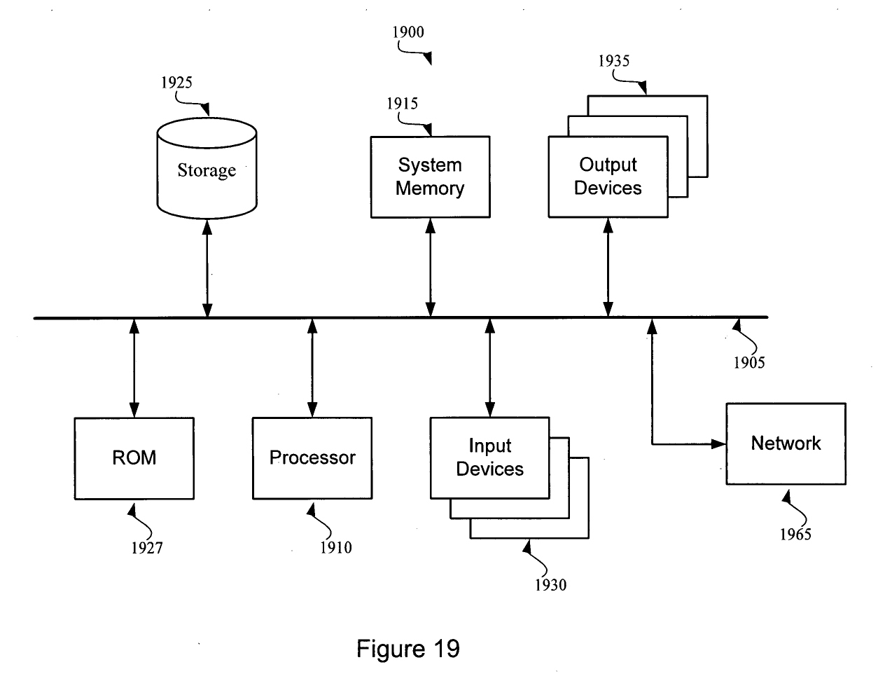

FIG. 19 conceptually illustrates a computer system 1900 with which some embodiments of the invention are implemented. Specifically, the computer system 1900 is for executing the various processes described herein or for illustrating the various modules that comprise the hardware devices used to implement the functionality described herein.

The computer system 1900 includes a bus 1905, a processor 1910, a system memory 1915, a read-only memory 1920, a permanent storage device 1925, input devices 1930, and output devices 1935. The bus 1905 collectively represents all system, peripheral, and chipset buses that support communication among internal devices of the computer system 1900. For instance, the bus 1905 communicatively connects the processor 1910 with the read-only memory 1920, the system memory 1915, and the permanent storage device 1925.

From these various memory units, the processor 1910 retrieves instructions to execute and data to process in order to execute the processes of the invention. In some embodiments the processor comprises a Field Programmable Gate Array (FPGA), an ASIC, or various other electronic modules for executing instructions. The read-only-memory (ROM) 1920 stores static data and instructions that are needed by the processor 1910 and other modules of the computer system. The permanent storage device 1925, on the other hand, is a read-and-write memory device. This device is a non-volatile memory unit that stores instruction and data even when the computer system 1900 is off. Some embodiments of the invention use a mass-storage device (such as a magnetic or optical disk and its corresponding disk drive) as the permanent storage device 1925. Some embodiments use one or more removable storage devices (flash memory card or memory stick) as the permanent storage device.

Like the permanent storage device 1925, the system memory 1915 is a read-and- write memory device. However, unlike storage device 1925, the system memory is a volatile read-and-write memory, such as a random access memory. The system memory stores some of the instructions and data that the processor needs at runtime.

Instructions and/or data needed to perform processes of some embodiments are stored in the system memory 1915, the permanent storage device 1925, the read-only memory 1920, or any combination of the three. For example, the various memory units contain instructions for processing multimedia items in accordance with some embodiments. From these various memory units, the processor 1910 retrieves instructions to execute and data to process in order to execute the processes of some embodiments.

The bus 1905 also connects to the input and output devices 1930 and 1935. The input devices enable the user to communicate information and select commands to the computer system. The input devices 1930 include alphanumeric keyboards and cursor-controllers. The output devices 1935 display images generated by the computer system. The output devices include printers and display devices, such as cathode ray tubes (CRT) or liquid crystal displays (LCD). Such displays can be used to view the multi-server control panel of some embodiments of the invention. Finally, as shown in FIG. 19, bus 1905 also couples computer 1900 to a network 1965 through a network adapter (not shown). In this manner, the computer can be a part of a network of computers (such as a local area network (“LAN”), a wide area network (“WAN”), or an Intranet) or a network of networks (such as the Internet).

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

We claim:

1. A method comprising:
a) receiving at least one parameter for identifying an item;
b) identifying a set of properties to associate with the item based on the at least one identification parameter, wherein the set of properties are for quantifying an amount of environmental conservation produced by the item; and
c) storing the at least one item identification parameter and the identified set of properties associated with the item in a computer readable medium for subsequent quantification of the environmental conservation produced the item.

2. The method of claim 1 further comprising issuing a tradable environmental commodity based on an amount of environmental conservation produced by at least two different items.

3. The method of claim 1 further comprising providing an amount of compensation to a registrant of said item based on the amount of environmental conservation produced by the item.

4. The method of claim 1, wherein the at least one parameter for identifying the item comprises a parameter that uniquely identifies the item from other items.

5. The method of claim 1, wherein identifying the set of properties, comprises using the at least one identification parameter to retrieve the set of properties from a database storing the set of properties.

6. The method of claim 5, wherein the properties stored within the database are populated by a manufacturer of said item and the at least one parameter for identifying the item is entered by a consumer of the said item.

7. The method of claim 1, wherein the set of properties comprise heuristics for computing the amount of environmental conservation produced by the item.

8. The method of claim 1, wherein the at least one parameter for identifying the item comprises usage parameters for specifying actual usage of the item.

9. The method of claim 8, wherein the set of properties for quantifying the amount of environmental conservation are modified by the usage parameters to specify an actual amount of environmental conservation related to an actual use of the item.

10. The method of claim 1, wherein identifying the set of properties comprises automatically retrieving the set of properties from at least one database of the item's manufacturer over an electronic interface.

11. The method of claim 1 further comprising computing the amount of the environmental conservation produced by the item.

12. The method of claim 11 further comprising providing a compensable amount to an entity that provided the item based on the computed amount of the environmental conservation.

13. A method comprising:
a) providing an interface for specifying identification information for at least one environmental conservation item; and
b) providing a registration engine for automatically associating a set of environmental conservation properties to quantify an amount of environmental conservation produced by the item based on the identification information specified for the item.

14. The method of claim 13, wherein the registration engine further automatically associates a protocol for defining a conversion between the environmental conservation properties of the item to the amount of environmental conservation produced by the item.

15. The method of claim 13, wherein the registration engine performs the automatic association of the set of environmental conservation properties by communicably coupling to a database of the item's manufacturer to retrieve the set of properties over an electronic interface.

16. The method of claim 13, wherein the item comprises a product that produces fewer emissions that a previously existing analog of the item.

17. The method of claim 13, wherein the quantifiable amount of environmental conservation comprises at least one or a quantifiable amount of reduced emissions, conserved energy, properly disposed of hazardous waste, and generated renewable energy.

18. The method of claim 13 further comprising issuing a tradable environmental commodity based on an amount of environmental conservation produced by at least two different items.

19. The method of claim 13, wherein said interface is further for displaying an amount of compensation to provide to a registrant of the item, said amount of compensation determined based on the amount of environmental conservation produced by the item.

20. A computer readable medium storing a computer program for execution by at least one processor, the computer program comprising sets of instructions for:
a) receiving at least one parameter for identifying an item;
b) identifying a set of properties to associate with the item based on the at least one identification parameter, wherein the set of properties are for quantifying an amount of environmental conservation produced by the item; and
c) storing the at least one item identification parameter and the identified set of properties associated with the item in a computer readable medium.
